(19) United States
(12) Patent Application Publication
(10) Pub. No.: US 2010/0039350 A1
(43) Pub. Date: Feb. 18, 2010

(54) METHODS, SYSTEMS, AND COMPUTER PROGRAM PRODUCTS FOR OPERATING HANDHELD ELECTRONIC DEVICES INCLUDING MOVEABLE DISPLAYS AND RELATED DEVICES

(75) Inventors: Ivan Nelson Wakefield, Cary, NC (US); Kevin Scott Kirkup, Raleigh, NC (US); Robert Flenniken, Raleigh, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/194,127

(22) Filed: Aug. 19, 2008

Related U.S. Application Data
(60) Provisional application No. 61/089,294, filed on Aug. 15, 2008.

(51) Int. Cl. G09G 5/00

(52) U.S. Cl. 345/1.3

(57) ABSTRACT

In a method of operating a handheld electronic device including a housing having a fixed display on a surface thereof and a moveable display that is configured slide along the surface to variably overlap portions of the fixed display, a signal is received from a position sensor adjacent the surface of the housing. A relative position of the moveable display with respect to the fixed display is determined in response to the signal from the position sensor. An image displayed on the moveable display and/or the fixed display is selectively manipulated according to the determined relative position of the moveable display to the fixed display. Related devices are also discussed.

### CROSS-REFERENCE TO RELATED PATENT APPLICATIONS

This application claims priority from U.S. Provisional Application Ser. No. 61/089,294 filed Aug. 15, 2008, the disclosure of which is hereby incorporated by reference herein in its entirety.

### FIELD OF THE INVENTION

The present invention relates to handheld electronic devices and, more particularly, to handheld electronic devices with display capabilities.

### BACKGROUND OF THE INVENTION

Consumers may now select from a wide array of handheld electronic devices, such as cellular mobile terminals, personal digital assistants (PDAs) and media players. Such devices typically provide audio and/or video user interfaces. For example, a mobile terminal may include a display, keypad, speaker and microphone, which together support telephony functions. These components may also support multimedia, gaming and other applications.

Producers of such devices constantly strive to provide new audio and visual interfaces to enhance user experience and, thus, garner greater market share. Thus, for example, handheld devices have been provided with touchscreen displays that may allow for user scrolling and other inputs, and display generators that may use accelerometer inputs to adaptively orient an image to adjust for the attitude at which the device is being held. For example, Apple Inc.'s iPhone may change its display between portrait and landscape modes responsive to an accelerometer that senses the attitude at which the device is being held.

### SUMMARY OF THE INVENTION

According to some embodiments of the present invention, a method of operating a handheld electronic device including a housing having a fixed display on a surface thereof and a moveable display that is configured slide along the surface of the housing to variably overlap portions of the fixed display includes receiving a signal from a position sensor adjacent the surface of the housing. A relative position of the moveable display with respect to the fixed display is determined in response to the signal from the position sensor. An image displayed on the moveable display and/or the fixed display is selectively manipulated according to the determined relative position of the moveable display to the fixed display.

In some embodiments, the signal from the position sensor may indicate a characteristic of a surface of the moveable display adjacent to the surface of the housing. The relative position of the surface of the moveable display with respect to the fixed display may be determined according to the surface characteristic indicated by the signal from the position sensor.

In other embodiments, a plurality of signals indicating movement of the moveable display may be received from the position sensor. Variations in the plurality of signals received from the position sensor may be detected, and the relative position of the moveable display may be determined according to the detected variations in the plurality of signals from the position sensor.

In some embodiments, the surface of the moveable display adjacent to the surface of the housing may be a reflective pattern including a plurality of regions having different respective optical reflectivities, and the signal from the position sensor may indicate one of the different optical reflectivities. In other embodiments, the surface of the moveable display adjacent to the surface of the housing may include a plurality of regions with different respective acoustical properties, and the signal from the sensor may indicate one of the different acoustical properties. In further embodiments, the surface of the moveable display adjacent to the surface of the housing may be a flexible film, and the signal from the sensor may indicate one of a plurality of deflections and/or positions of the flexible film.

In other embodiments, the surface of the moveable display adjacent to the surface of the housing may include a plurality of regions having different respective surface roughnesses, and the signal from the position sensor may indicate one of the different surface roughnesses. In further embodiments, the surface of the moveable display adjacent to the surface of the housing may include a plurality of regions with different respective resistivities, and the signal from the position sensor may indicate one of the different resistivities.

In some embodiments, one of the fixed display and the moveable display may include a magnet, and the other of the fixed display and the moveable display may include the position sensor. The signal from the position sensor may indicate one of a plurality of different voltages induced by the magnet based on a proximity thereto.

In other embodiments, the relative position of the moveable display with respect to the fixed display may be one of at least three positions in which the moveable display overlaps portions of the surface of the housing.

In some embodiments, an image displayed on the fixed display may be selectively manipulated according to the relative position of the moveable display to the fixed display. For example, an image displayed on the fixed display may be scrolled in a direction responsive to detecting movement of the moveable display in the direction. In addition, a user selection of an item displayed on one of the fixed display and the moveable display may be received, and information associated with the selected item may be displayed on the other of the fixed display and the moveable display responsive to receiving the user selection. Also, a window including an image portion within a boundary thereof may be displayed on one of the fixed display and the moveable display, and an enlarged view of the image portion within the boundary of the window may be displayed on the other of the fixed display and the moveable display.

In other embodiments, a composite image of a single scene may be displayed across the fixed and moveable displays. A portion of the single scene may be displayed on the moveable display and may be varied according to the relative position of the moveable display with respect to the fixed display. In addition, at least part of the portion of the single scene displayed on the moveable display may be magnified. Also, points of the portion of the single image displayed on the moveable display may be highlighted.

In some embodiments, movement of the moveable display may be detected in a direction along the surface of the housing. A device setting may be modified and/or a device function may be initiated responsive to detecting the movement of the moveable display.

In other embodiments, the fixed display may be a first display, and the device may further include a second display fixed in or deployable to a side-by-side arrangement with the first display. The moveable display may be a third display fixed in or deployable to an overlapping arrangement with respect to the first and/or second displays in the side-by-side arrangement. A composite image of a single scene may be displayed across the first, second and third displays. A portion of the single scene displayed on the third display may correspond to the relative position of the third display with respect to the first and second displays.

According to further embodiments of the present invention, a handheld electronic device, such as a mobile terminal, PDA, media player or the like, includes a housing having a fixed display on a surface thereof. A moveable display on the surface of the housing is configured slide along the surface to variably overlap portions of the fixed display. A position sensor adjacent the surface of the housing is configured to generate a signal indicating a relative position of the moveable display with respect to the fixed display. A display controller is configured to determine the relative position of the moveable display with respect to the fixed display in response to the signal generated by the position sensor. and is configured to selectively manipulate an image displayed on the moveable display and/or the fixed display according to the relative position of the moveable display to the fixed display.

In some embodiments, the display controller may be configured to detect movement of the moveable display in a direction along the surface of the housing responsive to the signal from the position sensor. The display controller may be further configured to scroll an image displayed on the fixed display in the direction responsive to detecting the movement of the moveable display in the direction.

In other embodiments, the display controller may be configured to display information associated with a selected item on one of the fixed display and the moveable display responsive to receiving a signal indicating user selection of the item on the other of the fixed display and the moveable display.

In some embodiments, the display controller may be configured to display a window including an image portion within a boundary thereof on one of the fixed display and the moveable display. The display controller may be further configured to display an enlarged view of the image portion within the boundary of the window on the other of the fixed display and the moveable display.

In other embodiments, the display controller may be configured to display a composite image of a single scene across the fixed and moveable displays such that a portion of the single scene is displayed on the moveable display and is varied according to the relative position of the moveable display with respect to the fixed display. The display controller may be further configured to magnify and/or highlight points on at least part of the portion of the single scene displayed on the moveable display.

In some embodiments, the display controller may be configured to detect movement of the moveable display in a direction along the surface of the housing responsive to the signal from the position sensor. The display controller may be further configured to modify a device setting and/or initiate a device function responsive to detecting the movement of the moveable display.

Other electronic devices, methods, and/or computer program products according to embodiments of the invention will be or become apparent to one with skill in the art upon review of the following drawings and detailed description. It is intended that all such additional electronic devices, methods, and computer program products be included within this description, be within the scope of the present invention, and be protected by the accompanying claims.

### BRIEF DESCRIPTION OF THE DRAWINGS

FIGS. 1A-1C illustrate a mobile terminal according to some embodiments of the present invention.

FIGS. 2A-2C illustrate a mobile terminal according to other embodiments of the present invention.

FIG. 3A is a side view illustrating the mobile terminal of FIGS. 2A-2C.

FIGS. 3B-3C are exploded views illustrating the moveable display and the housing of the mobile terminal of FIGS. 2A-2C, respectively.

FIG. 4 is a schematic diagram that illustrates a system for selectively manipulating image presentation in fixed and/or moveable displays in mobile terminals according to some embodiments of the present invention.

FIG. 5 is a schematic diagram illustrating a mobile terminal according to some embodiments of the present invention.

FIG. 6 is a flowchart illustrating example operations for selectively manipulating image presentation in fixed and/or moveable displays in mobile terminals according to some embodiments of the present invention.

FIGS. 7A-7D illustrate operation of a moveable display in a mobile terminal according to some embodiments of the present invention.

FIGS. 8A-8D illustrate operation of a moveable display in a mobile terminal according to other embodiments of the present invention.

FIGS. 9A-9C illustrate operation of a moveable display in a mobile terminal according to still other embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to flowcharts in which each block represents a circuit element, module, or portion of code which includes one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Some embodiments of the present invention arise from a realization that, in a handheld electronic device including a moveable display that may be variably overlapped across one or more other displays in different but parallel planes, the moveable display may be used to provide a unique user interface. For example, a “clamshell” device, such as a mobile terminal, may include first and second displays fixedly mounted on respective portions of a hinged clamshell housing and a third, moveable display that is configured to slide across the two fixed displays when the clamshell housing is in an open position. In such a configuration, the third sliding display may partially or fully overlap either of the first and second fixed displays. When this moveable display is moved over the hinge to bridge across the other two displays, the displays may change their displayed images, for example, to present components of a composite image having a size greater than any of the individual displays. The moveable display can display the portion of the image on the first and/or second displays that is covered by the moveable display, and/or other images, for example, a magnified image, a more detailed image, and/or images relating to one or more other functions of the mobile terminal. Handheld devices including moveable displays are also described in commonly-owned U.S. patent application Ser. No. 12/172,451 to Demuynck et al., entitled “HANDHELD ELECTRONIC DEVICES WITH MOVEABLE DISPLAYS AND DYNAMIC DISPLAY CONTROLS,” the disclosure of which is incorporated by reference herein in its entirety.

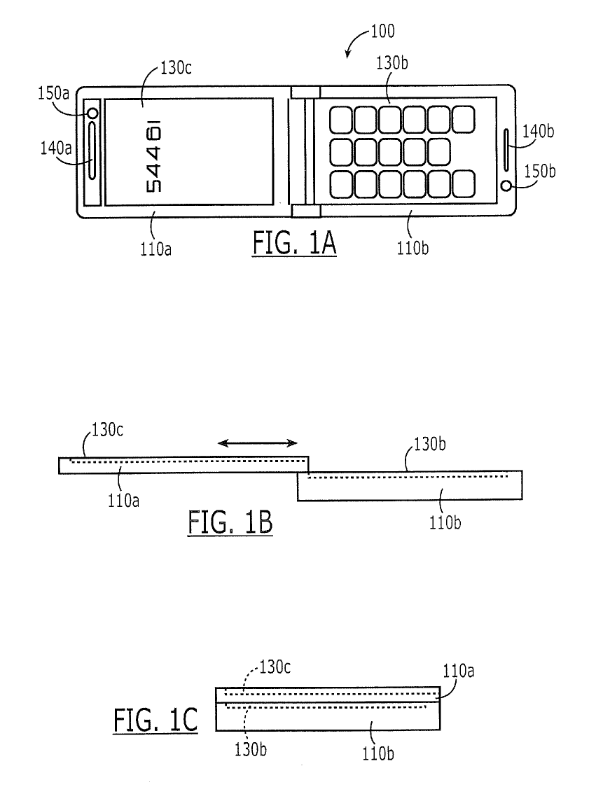

FIGS. 1A-1C illustrate a “slider”-type mobile terminal 100 including a moveable display 130c according to some embodiments of the present invention. In particular, FIG. 1A illustrates a top view of the mobile terminal 100, while FIGS. 1B and 1C illustrate side views of the mobile terminal 100 in “open” and “closed” configurations, respectively. The mobile terminal 100 has a housing including housing portions 110a and 110b. Speakers 140a, 140b and microphones 150a, 150b are positioned on respective ones of the housing portions 110a, 110b. A display 130b is fixedly mounted on the housing portion 110b, while housing portion 110a includes a moveable display 130c. As such, the displays 130b, 130c are arranged side-by-side in different but parallel planes when the mobile terminal 100 is in an open position, as shown in FIG. 1B, but are stacked when the mobile terminal 100 is in a closed position, as shown in FIG. 1C. As illustrated, the displays 130a, 130c may be touch-sensitive displays that are further configured to accept user inputs.

As further shown in FIGS. 1A-1C, the moveable display 130c is configured to slide along the surface of the housing 110b to variably overlap the fixed display 130b. In particular, as shown in FIG. 1C, when the mobile terminal 100 is in the closed position, the moveable display 130c may be positioned to completely overlap the fixed display 130b, such that the fixed display 130b is sandwiched between the housing portions 110a, 110b. When the mobile terminal 100 is in the open position, as shown in FIG. 1B, the moveable display 130c may slide along the surface of the housing 110b to be positioned relative to the fixed display in any number of predetermined, or in some embodiments, infinitely variable positions. For example, in a first position, the moveable display 130c may predominantly overlap the first display 130b, in a second position, the moveable display 130c may partially overlap a portion of the housing 130b on one side of the fixed display 130b, and in a third position, the moveable display 130c may partially overlap a portion of the housing 110b on the other side of the fixed display 130b.

It will be appreciated that movement of the moveable display 130c may be achieved in any of a number of different ways. For example, the moveable display 130c may have a tab or other feature that a user may engage to push the moveable display 130c across the fixed display 130b. The moveable display 130c may also be moved using a mechanical or electromechanical actuator, such as a spring loaded actuator or motor drive. In some embodiments, the moveable display 130c may be magnetically coupled to the housing 110b such that the moveable display 130c may slide in any direction along the surface of the housing 110b to allow greater freedom of movement.

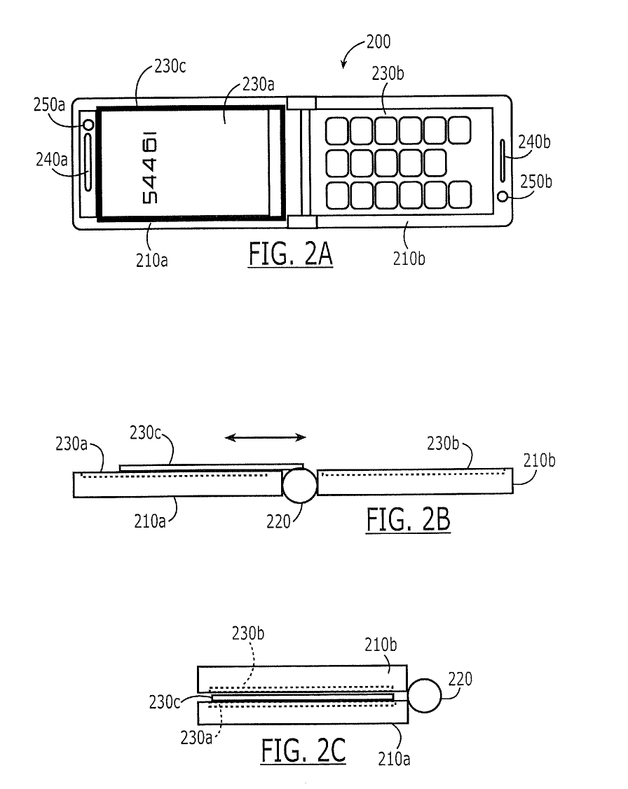

FIGS. 2A-2C illustrate a “clamshell”-type mobile terminal 200 including a moveable display 230c according to some embodiments of the present invention. The mobile terminal 200 has a clamshell housing including housing portions 210a, 210b connected by a hinge 220. Speakers 240a, 240b and microphones 250a, 250b are positioned on respective ones of the clamshell housing portions 210a, 210b. First and second displays 230a, 230b are fixedly mounted on respective ones of the clamshell housing portions 210a, 210b, such that the displays 230a, 230b are arranged side-by-side when the mobile terminal 200 is in an open position, as shown in FIG. 2B, and such that the displays 230a, 230b are opposed when the mobile terminal 200 is in a closed position, as shown in FIG. 2C. As illustrated, the displays 230a, 230b may be touch-sensitive displays that are further configured to accept user inputs.

As further shown in FIGS. 2A-2C, the mobile terminal 200 includes a third, moveable display 230c that is configured to variably overlap the first and second displays 230a, 230b. In particular, as shown in FIG. 2C, when the mobile terminal 200 is in the closed position, the moveable display 230c may be positioned overlapping either one of the fixed displays 230a, 230b, such that the moveable display 230c is sandwiched between the two fixed displays 230a, 230b. When the mobile terminal 200 is in the open position, as shown in FIG. 2B, the moveable display 230c may be free to slide along the surfaces of the housings 210a, 210b and across the hinge 220 to variably overlap one or both of the two fixed displays 230a, 230b. The moveable display 230c may be positioned along the surface of the housings 210a, 210b in any number of predetermined positions relative to the fixed displays 230a, 230b. For example, in a first position, the moveable display 230c may predominantly overlap the first display 230a, in a second position, the moveable display 230c may predominantly overlap the second display 230b, and in a third position, the moveable display 230c may partially overlap portions of both the fixed displays 230a, 230b. In other embodiments, the relative position of the moveable display 230c with respect to the fixed displays 230a, 230b may be infinitely variable along the surface of the housings 210a, 210b.

As similarly discussed above with reference to FIGS. 1A-1C, movement of the moveable display 230c may be achieved in any of a number of different ways. For example, in some embodiments, the moveable display 230c may include a tab or other feature that a user may engage to push the moveable display 230c across the fixed displays 230a, 230b, while in other embodiments, the moveable display 230c may be moved using a mechanical or electromechanical actuator, such as a spring loaded actuator or motor drive.

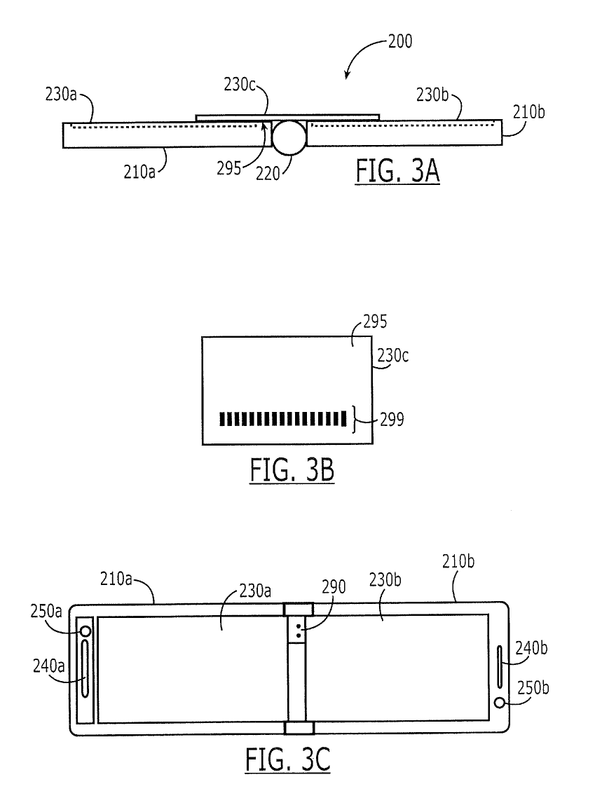

FIGS. 3A-3C illustrate apparatus and methods for sensing the relative position of the moveable display 230c with respect to the fixed displays 230a, 230b of the mobile terminal 200 of FIGS. 2A-2C. In particular, FIG. 3A illustrates a side view of the mobile terminal 200 in the open configuration, FIG. 3B illustrates an underside of the moveable display 230c that faces the fixed displays 230a, 230b, and FIG. 3C illustrates the housings 210a, 210b in the open configuration with the moveable display 230c removed.

Referring now to FIGS. 3A-3C, the mobile terminal 200 includes a position sensor 290 adjacent the surface 295 of the moveable display 230c that slides along the surfaces of the housings 210a, 210b. As shown in FIG. 3C, the position sensor 290 is integrated in the hinge 220 of the mobile terminal 200; however, the position sensor 290 may be provided in the housings 210a, 210b and/or in the moveable display 230c in other embodiments. The position sensor 290 is configured to generate a signal indicating a relative position of the moveable display 230c with respect to the fixed displays 230a, 230b and/or the housings 210a, 210b. The signal from the position sensor may be a digital signal indicating any number of discrete positions of the moveable display 230c, or may be an analog signal indicating one of an infinite number of positions of the moveable display 230e relative to the fixed displays 230a, 230b.

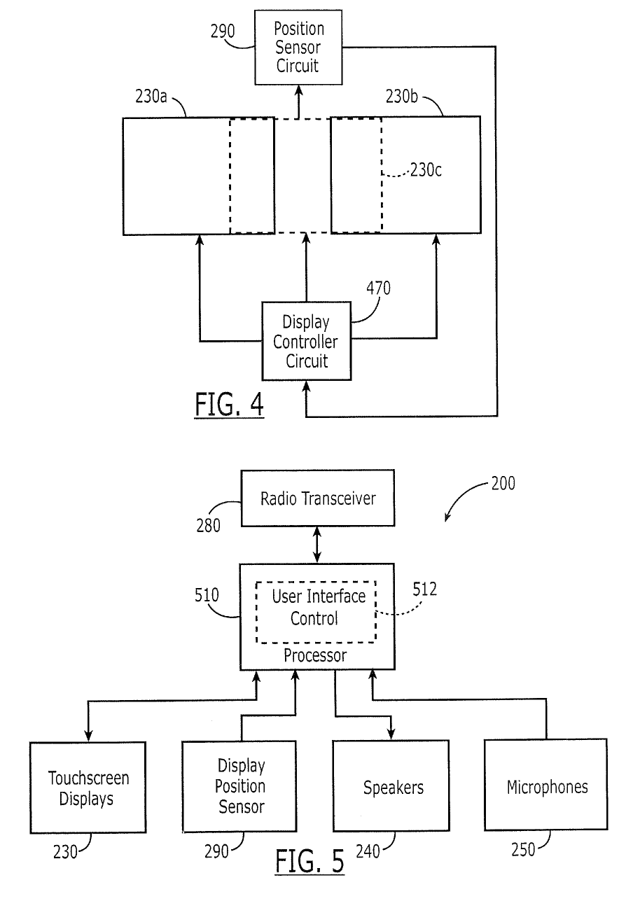

In particular embodiments, the signal generated by the position sensor 290 may indicate characteristics of the surface 295 of the moveable display 230c, which may be used to determine the relative position of the moveable display 230c by a display controller as further discussed below with reference to FIG. 4. For example, the housings 210a, 210b and/or the hinge 220 may include a light emitting diode (LED) or other light source configured to illuminate the surface 295 of the moveable display 230c, the position sensor 290 may be an optoelectronic sensor configured to take successive images of the surface 295 of the moveable display 230c, and the display controller may be configured to detect relative motion of the moveable display 230c based on the variations in the images of the surface 295 received from the position sensor 290.

As shown in FIG. 3B, in some embodiments, the surface 295 of the moveable display 230 includes a pattern 299 having different surface characteristics. The position sensor 290 may be configured to detect the different surface properties of the pattern 299, and thereby generate a signal indicating the detected surface properties. For example, the pattern 299 may include different regions having different optical reflectivities, different surface roughnesses, different resistivities, different flexibilities, and/or different acoustical properties. In particular, in embodiments where the pattern 299 includes different regions with different optical reflectivities, an LED or other light source may be used to illuminate the surface 295 of the moveable display 230c including the pattern 299. As such, when the moveable display 230c is moved, the signals from the position sensor 290 may indicate a number of detected variations in reflectivity, which may be counted to determine the position of the moveable display 230c relative to the position of the sensor 290 in the housing. Alternatively, each of the different reflective portions of the pattern 299 may be associated with a predetermined reflectivity and a predetermined position on the surface 295, such that the particular signal received from the sensor 290 may indicate an optical reflectivity that may be correlated to a particular position of the moveable display 230c relative to the sensor 290 and/or the fixed displays 230a, 230b.

In embodiments where the pattern 299 includes different regions with different acoustical properties, each region may be associated with a known position on the surface 295 and a known acoustical “signature”. A sound source within the housings 210a, 210b and/or hinge 220 may thereby direct an acoustic signal toward the surface 295 of the moveable display 230c, which may be reflected differently by the different regions of the pattern 299. The electrical signals generated by the position sensor 290 may indicate detected variations in the reflected acoustic signal, which may be correlated to the position of the moveable display 230c relative to the position of the sensor 290 in the housing. In some embodiments, a signal from the internal speaker(s) 240a, 240b of the mobile terminal 200 may be configured to provide the sound source.

In other embodiments the pattern 299 may be a flexible film on the surface 295 of the moveable display 230c including different regions with different physical flexibilities, which are respectively associated with known positions on the surface 295. The position sensor 290 may be a mechanical sensor that is configured to detect the different flexibility of each region, for example, based on physical deflection of the mechanical sensor when it contacts each region and/or physical deflection of each region of the film when it contacts the mechanical sensor. As such, the signal from the sensor 290 may indicate the relative position of the moveable display based on the amount of deflection of the portion of the film in a particular region and/or the amount of deflection of the sensor 290 when in contact with that region. Alternatively, the flexible film may be configured to be advanced and/or retracted from the moveable display 230c, and the relative position of the moveable display 230c may be determined based on the amount of advancement/retraction of the flexible film.

In embodiments where the pattern 299 includes different regions on the surface 295 of the moveable display 230c with different surface roughnesses, the position sensor 290 may be an optoelectronic sensor configured to detect the differences in roughnesses in each region, which may be correlated to different positions of the moveable display 230c. Likewise, in embodiments where the pattern 299 includes different regions with different resistive properties, the position sensor 290 may include an electrical contact on the adjacent surface of the housings 210a, 210b and/or hinge 220 and a voltage divider circuit, which may be used to detect and correlate the different resistances of the regions to relative positions of the moveable display 230c.

In other embodiments, the position sensor 290 may be a Hall effect sensor configured to vary its output voltage in response to detected changes in magnetic field. For example, the moveable display 230c may include a permanent magnet, and the signals provided by the sensor 290 in response to movement of the magnet in the moveable display 230c may be used to determine the relative position of the moveable display 230c with respect to the position of the sensor 290. Alternatively, the sensor 290 may be provided in the moveable display, and the magnet may be provided in the housings 210a, 210b and/or the hinge 220.

It will be appreciated that the techniques for position detection described above with reference to FIGS. 3A-3C are provided for purposes of illustration, and that a variety of other position sensing techniques may be used with the present invention. For example, the position of the moveable display 230c may be sensed using a voltage divider circuit including a potentiometer (e.g., a resistive strip and wiper) or by circuits employing capacitive or magnetic sensors. Such sensors may measure position with respect to any of a number of different points of references, for example, with respect to certain features of the device, such as the hinge 220. It will be further appreciated that, although embodiments including a single display that moves with respect to two fixed displays are shown, other embodiments of the present invention may use more than one moveable display and/or more or fewer fixed displays, as well as displays that have different relative movements. As such, it will be understood that the apparatus and methods of FIGS. 3A-3C can be similarly employed to sense the relative position of the moveable display 130c with respect to the fixed display 130b of the mobile terminal 100 of FIGS. 1A-1C. It will also be understood that, although embodiments in a mobile terminal application are illustrated, other embodiments may be implemented in other types of handheld devices, such as PDAs or media players.

According to some embodiments of the present invention, images presented by the displays 130b, 130c of FIGS. 1A-1C and/or 230a, 230b, 230c of FIGS. 2A-2C may be selectively manipulated responsive to the determined position of the moveable displays 130c and 230c in relation to their respective fixed displays 130b and 230a, 230b. For example, as shown in FIG. 4 with reference to the mobile terminal 200 of FIGS. 2A-2C, the position sensor 290 is configured to generate a position sensor signal that is indicative of a relative position of the moveable display 230c with respect to the fixed displays 230a, 230b. The position sensor 290 may include any of a number of different types of sensor devices, including, but not limited to electrical contacts, potentiometers, magnetic sensors and capacitive sensors, as well as the particular sensor configurations discussed above with reference to FIGS. 3A-3C. A display controller circuit 470 may be configured to receive the position sensor signal and control the display of images on the displays 230a, 230b, 230c responsive thereto. The display controller circuit 470 may be further configured to manipulate or change the images on the displays 230a, 230b, 230c responsive to user inputs. For example, the displays 230a, 230b, 230c may be touchscreen displays that may be used to accept the user inputs, and the display controller circuit 470 may magnify, scroll, highlight, and/or annotate portions of the images shown on one or more of the displays 230a, 230b, 230c in response to the user inputs, as discussed in detail below. Also, user inputs may be provided by moving the moveable display 230c and/or by using other devices, such as keys or joysticks.

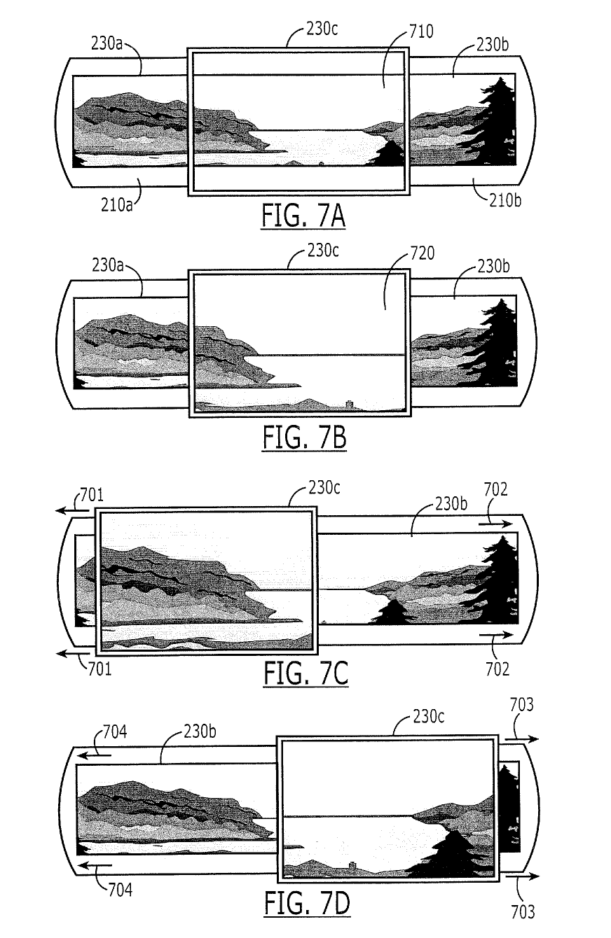

FIG. 5 is a schematic diagram illustrating an exemplary implementation for the mobile terminal 200 of FIGS. 2A-2C. The mobile terminal 200 includes a radio transceiver 280, touchscreen displays 230, speakers 240, microphones 250, and a display position sensor 290. The mobile terminal 200 further includes a processor 510 (e.g., a microcontroller or microprocessor and associated peripheral circuitry, such as memory, input/output circuitry, audio circuits, display driver circuits and the like) that is operatively associated with the displays 230, speakers 240, microphones 250, display position sensor 290 and radio transceiver 280. The processor 510 may execute program code that is configured to create a user interface control function 512 that controls the displays 230, speakers 240, and/or microphones 250. In particular, the user interface control function 512 may be configured to control image presentation on the displays 230 responsive to a position sensor signal provided by the display position sensor 290, as discussed above with reference to FIG. 4 and as further discussed below with reference to FIGS. 7-9.

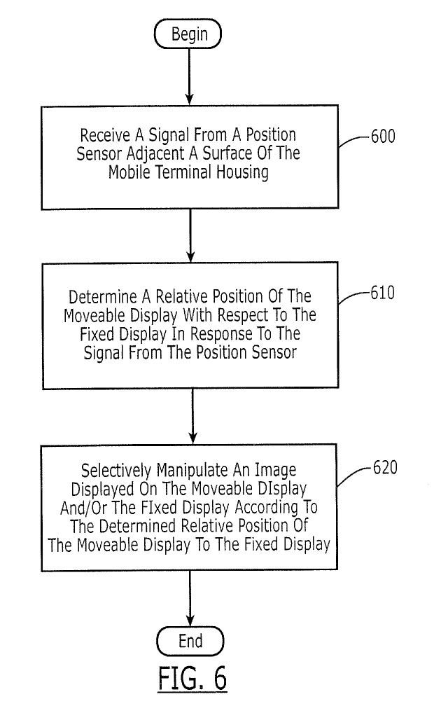

FIG. 6 illustrates example operations for selectively manipulating images displayed on fixed and/or moveable displays in a handheld electronic device, such as a mobile terminal, according to some embodiments of the present invention. For example, the operations illustrated in FIG. 6 may be performed by the display controller circuit 470 of FIG. 4. Referring to FIG. 6, a signal from a position sensor adjacent a surface of a mobile terminal housing is received (block 600). The signal may indicate a position of the moveable display relative to one or more fixed displays on the mobile terminal housing. In particular embodiments, the signal may indicate one or more characteristics or properties of a surface of the moveable display adjacent to the surface of the housing. Accordingly, the relative position of the moveable display with respect to the fixed display(s) is determined according to the signal from the position sensor (block 610). For example, multiple signals may be received from the position sensor, and the relative position of the moveable display may be determined according to detected variations in the signals from the position sensor. In response, an image displayed on the moveable display is manipulated based on the determined relative position of the moveable display to the fixed display(s) (block 620). Images displayed on the fixed display(s) may also be controlled according to the relative position of the moveable display. Examples of such image control are provided below with reference to FIGS. 7-9.

FIGS. 7A-7D illustrate examples of selectively manipulating images shown on a moveable display in a mobile terminal including three displays, such as the mobile terminal 200 of FIGS. 2A-2C. Referring to FIG. 7A, when the mobile terminal 200 is in the open configuration and in a camera mode, a panoramic image of a single scene is provided as a composite image across the first, second, and third displays 230a, 230b, 230c. The portion 710 of the scene displayed on the moveable display 230c corresponds to the relative position of the moveable display 230c with respect to the fixed displays 230a, 230b. As shown in FIG. 7B, in response to a user input indicating a desire to view a portion of the displayed scene in greater detail, the moveable display 230c magnifies the portion 710 of the scene displayed thereon, while the full viewfinder image is maintained on the first and second fixed displays 230a, 230b. In particular, the image shown on the portions of the fixed displays 230a, 230b that are covered by the moveable display 230c is magnified on the moveable display 230c to provide an more detailed view 720. As further shown in FIG. 7C and FIG. 7D, the moveable display 230c is configured to zoom-in on the left (FIG. 7C) or right (FIG. 7D) portions of the panoramic image in response to sliding the moveable display 230c to the left or right, respectively. As such, the magnified view 720 presented on the moveable display 230c may be changed based on the relative position of the moveable display 230c with respect to the fixed displays 230a, 230b. More generally, the moveable display 230c may be configured to display a manipulated or altered version of an image shown on the underlying fixed display(s) 230a, 230b.

As also shown in FIGS. 7C-7D, the moveable display may be configured to be moved beyond leftmost (indicated by arrows 701 in FIG. 7C) or rightmost (indicated by arrows 703 FIG. 7D) detent positions relative to the fixed displays 230a, 230b. For example, the moveable display 230c and/or the housing portions 210a, 210b may include a spring-loaded mechanism that is configured to return the moveable display 230 back to the respective detent positions. In response to detecting such movements of the moveable display 230c along the surfaces of the housings 210a, 210b, the fixed displays 230a, 230b may be configured to scroll the single scene to right (indicated by arrows 702) and/or left (indicated by arrows 704), respectively. Detected accelerometer inputs, for example, responsive to tilting the mobile terminal 200 towards or away from the user, may be used to control scrolling the image up or down. Movement of the moveable display 230c may also be used to select the image to capture and/or to set the focus of the camera.

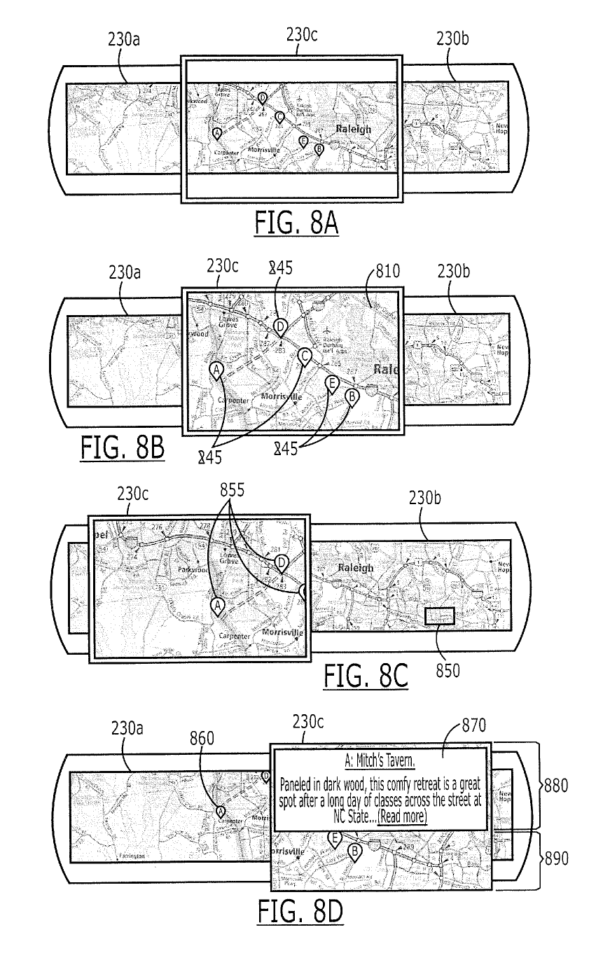

FIGS. 8A-8D illustrate additional examples of manipulating images shown on a moveable display and/or a fixed display in the mobile terminal 200 of FIGS. 2A-2C. As shown in FIG. 8A, when the mobile terminal 200 is in the open configuration and is used to view map information in a web browser mode, a map of a single area is provided as a composite image across the first, second, and third displays 230a, 230b, 230c.

FIG. 8B illustrates that the moveable display may act as a “magnifying glass” for an image displayed on the fixed displays 230a, 230b. For example, the moveable display 230c may be configured to zoom-in on a specific portion of the map to provide a close-up view 810, for instance, to display street names and/or other more detailed information. In particular, the portions of the map shown on the fixed displays 230a, 230b that are covered by the moveable display 230c may be magnified on the moveable display 230c. The moveable display 230c may also be moved left and right to zoom-in on different areas of the map. As such, the magnified view 810 presented on the moveable display 230c may be changed based on the relative position of the moveable display 230c with respect to the fixed displays 230a, 230b.

In addition and/or alternatively, as further shown in FIG. 8B, the moveable display 230c may be configured to highlight particular points 845 when the moveable display is moved over portions map shown on the fixed displays 230a, 230b. For example, the moveable display 230c may be configured to highlight the particular points 845 in response to receiving a user-entered criteria indicating points-of-interest to the user. In some embodiments, the highlighted points 845 may be difficult to make out and/or may not otherwise be visible on the fixed displays 230a, 230b.

FIG. 8C illustrates that the fixed displays 230a, 230b may be configured to display a “window” or box 850 that includes a portion of the displayed map or other images within the boundaries of the window 850. The window 850 may be moved within the fixed displays 230a, 230b, and the moveable display 230c may be configured to display an alternate view (such as an enlarged or reduced view) of the portion of the image within the boundaries of the window 850. For example, a user may “drag” the window 850 over a particular portion of one of the fixed displays 230a, 230b, and an enlarged view the portion of the map within the bounds of the window 850 may be displayed on the moveable display 230c in response to the user input. Also, scrolling or movement of the window 850 over different portions of the image shown on the fixed displays 230a, 230b may result in scrolling in the moveable display 230c without movement of the moveable display 230c and/or regardless of the position of the moveable display 230c relative to the fixed displays 230a, 230b. The window 850 may also be re-sized in response to a user input to cover a greater or lesser portion of the fixed displays 230a, 230b. In some embodiments, the window 850 may be “dragged” from the fixed display 230b, across the moveable display 230c, and onto the fixed display 230a, or vice versa. Points of interest 855 within the boundaries of the window 850 may also be displayed on the moveable display 230c, as discussed above.

The moveable display 230c may also be used to display additional and/or more detailed information associated with an item on one of the fixed displays 230a, 230b In particular, as shown in FIG. 8D, in response to receiving a user selection of a point-of-interest 860 shown on the fixed display 230a, the moveable display 230c is configured to display detailed information 870 associated with the selected point of interest. The detailed information 870 may be provided in a portion 880 of the moveable display 230c such that a remaining portion 890 of the moveable display 230c is still available to magnify or otherwise view the portion of the map therebelow. Also, the detailed information 870 may be expanded to cover the entire moveable display 230c (for example, by selecting “Read More”), and/or may be provided in a semi-transparent manner such that the image covered by the detailed information is still visible. In addition, the movable display 230c may be used to select an item from the map and/or from a list or menu for displaying the additional information. For example, a portion (for example, a sliver or target area) of the moveable display 230c may be designated for use in selecting items, and items may be selected by moving this portion of the moveable display 230c over an item shown in one of the fixed displays 230a, 230b.

Although illustrated in FIGS. 7A-7D and 8A-8D as having particular functionalities associated with the moveable display 230c and the fixed displays 230a, 230b, it is to be understood that, in other embodiments, the particular functionalities of the moveable display 230c and the fixed displays 230a, 230b may be reversed. For example, in FIG. 7A, the fixed displays 230a, 230b may be configured to display magnified views, while the moveable display 230c may be configured to display a normal and/or reduced-size view of the single scene. Likewise, in FIGS. 8C and 8D, movement of a window 850 in the moveable display 230c and/or selection of an item in the moveable display may highlight the particular points 855 and/or display additional information in one or both of the fixed displays 230a, 230b. Also, in some embodiments, the fixed displays 230a, 230b and/or the moveable display 230c may be touchscreen displays including sensors that are configured to receive touch-based inputs from the user.

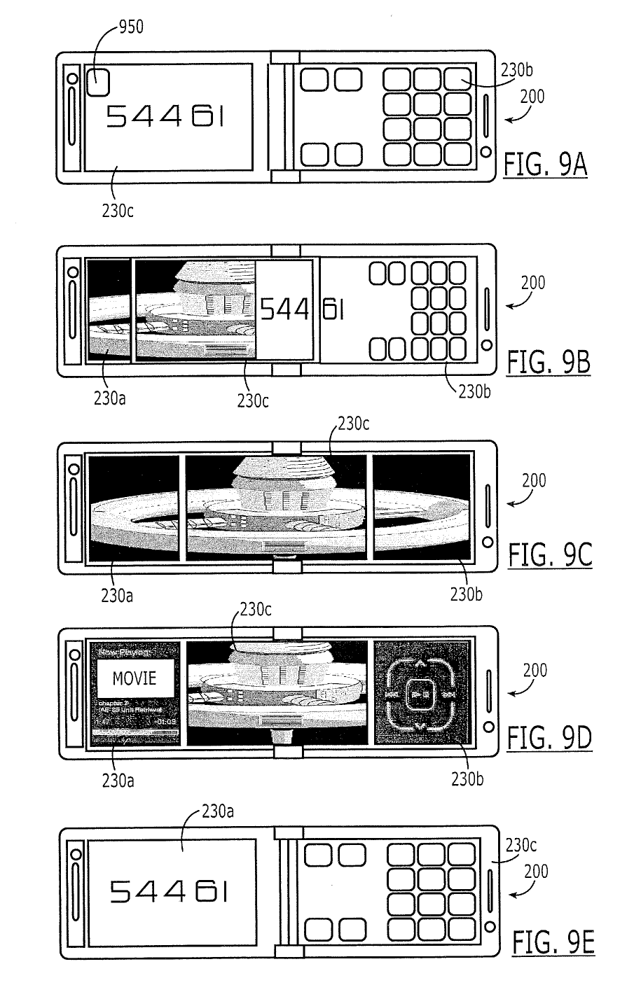

The movable display 230c may also be used as input for modifying a device setting and/or initiating a device function, such as answering a call, making a call, making a purchase, selecting an item to display more information, and/or initiating other functions. For example, as shown in FIGS. 9A-9C, detection of the relative position and/or movement of the moveable display 230c may be used to transition from a telephone interface mode in which each display presents a discrete image (FIG. 9A) to a widescreen multimedia mode in which the displays collectively provide a composite image (FIG. 9C). In particular, as shown in FIG. 9A, when the moveable display 230c is in a leftmost detent position predominantly overlapping the first fixed display 230a, the moveable display 230c and the non-occluded fixed display 230b are used to show respective images supporting a telephone user interface, e.g., a keypad image is displayed on the fixed display 230b and an informational image is displayed on the moveable display 230c. A tab 950 is included in the image on the moveable display 230c, indicative of the presence of an underlying alternative image (in the illustrated case, a video) that may be accessed responsive to movement of the moveable display 230c.

Referring to FIG. 9B, as the user begins to move the moveable display 230c to reveal a portion of the underlying fixed display 230a, a video image begins to be “previewed” on the fixed display 230a and the moveable display 230c, while portions of the telephone interface image “slide” onto the other fixed display 230b. When the moveable display 230c is moved to a centered detent position as shown in FIG. 9C, the video image is displayed in composite across the two fixed displays 230a, 230b and the centered moveable display 230c, thus providing a widescreen image. As shown in FIG. 9D, a user input to one or more of the displays 230a, 230b, 230c may cause the displays 230a, 230b, 230c to transition to a new display mode in which display of the video is limited to the center display 230c, and the outboard displays 230a, 230b provide information and/or user control images. As shown in FIG. 9E, sliding the moveable display 230c all the way to a rightmost detent position causes reversion to a telephone user interface image, this time with the moveable display 230c providing a keypad image and the left display 230a providing an informational image. Thus, detection of movement of the moveable display to a leftmost or rightmost detent position may be used to imitate a phone mode and/or answer a call, while detection of movement of the moveable display to a middle detent position may be used to initiate a widescreen mode, for instance, for use with camera and/or video playback functions.

It will be appreciated that a variety of other display movement controlled display transitions may be provided in further embodiments of the present invention. For example, instead of providing mirror image displays in the far left and far right detent positions of the moveable display 230c, these positions may be used to display different user interface image sets, such as different telephone user interface images or a telephone interface image and a music player interface image, respectively. Instead of triggering a composite display as shown in FIG. 9C, movement of the moveable display 230c to the center position could trigger display of a video selection interface, in which a user could select a video for presentation, followed by transition to display of the selected video in the widescreen mode shown in FIG. 9C.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A method of operating a handheld electronic device comprising a housing including a fixed display on a surface thereof and a moveable display that is configured slide along the surface of the housing to variably overlap portions of the fixed display, the method comprising:
receiving a signal from a position sensor adjacent the surface of the housing;
determining a relative position of the moveable display with respect to the fixed display in response to the signal from the position sensor; and
selectively manipulating an image displayed on the moveable display and/or the fixed display according to the determined relative position of the moveable display to the fixed display.

2. The method of claim 1, wherein the signal from the position sensor indicates a characteristic of a surface of the moveable display adjacent to the surface of the housing, and wherein determining the relative position of the moveable display comprises:
determining the relative position of the surface of the moveable display with respect to the fixed display according to the surface characteristic indicated by the signal from the position sensor.

3. The method of claim 2, wherein receiving the signal from the position sensor comprises receiving a plurality of signals from the position sensor indicating movement of the moveable display, and wherein determining the relative position further comprises:
detecting variations in the plurality of signals received from the position sensor; and
determining the relative position of the moveable display according to the detected variations in the plurality of signals from the position sensor.

4. The method of claim 2, wherein the surface of the moveable display adjacent to the surface of the housing comprises at least one of:
a reflective pattern including a plurality of regions having different respective optical reflectivities, wherein the signal from the position sensor indicates one of the different optical reflectivities;
a plurality of regions with different respective acoustical properties, wherein the signal from the sensor indicates one of the different acoustical properties;
a flexible film, wherein the signal from the sensor indicates one of a plurality of deflections and/or positions of the flexible film;
a plurality of regions respectively including different surface roughnesses, wherein the signal from the position sensor indicates one of the different surface roughnesses; and
a plurality of regions with different respective resistivities, wherein the signal from the position sensor indicates one of the different resistivities.

5. The method of claim 1, wherein one of the fixed display and the moveable display includes a magnet, wherein the other of the fixed display and the moveable display includes the position sensor, and wherein the signal from the position sensor indicates one of a plurality of different voltages induced by the magnet based on a proximity thereto.

6. The method of claim 1, wherein the relative position of the moveable display with respect to the fixed display comprises one of at least three positions in which the moveable display overlaps portions of the surface of the housing.

7. The method of claim 1, wherein selectively manipulating the image displayed on the fixed display comprises:
detecting movement of the moveable display in a direction along the surface of the housing; and
scrolling the image displayed on the fixed display in the direction responsive to detecting the movement of the moveable display in the direction.

8. The method of claim 1, wherein selectively manipulating the image displayed on the fixed and/or moveable displays further comprises:
receiving a user selection of an item displayed on one of the fixed display and the moveable display; and
displaying information associated with the selected item on the other of the fixed display and the moveable display responsive to receiving the user selection.

9. The method of claim 1, wherein selectively manipulating the images displayed on the fixed and/or moveable displays further comprises:
displaying a window including an image portion within a boundary thereof on one of the fixed display and the moveable display; and
displaying an enlarged view of the image portion within the boundary of the window on the other of the fixed display and the moveable display.

10. The method of claim 1, further comprising:
displaying a composite image of a single scene across the fixed and moveable displays such that a portion of the single scene is displayed on the moveable display and is varied according to the relative position of the moveable display with respect to the fixed display.

11. The method of claim 10, wherein selectively manipulating the image displayed on the moveable display further comprises:
magnifying at least part of the portion of the single scene displayed on the moveable display.

12. The method of claim 10, wherein selectively manipulating the image displayed on the moveable display further comprises:
highlighting points of the portion of the single image displayed on the moveable display.

13. The method of claim 1, further comprising:
detecting movement of the moveable display in a direction along the surface of the housing; and
modifying a device setting and/or initiating a device function responsive to detecting the movement of the moveable display.

14. The method of claim 1, wherein the fixed display comprises a first display, wherein the device further comprises a second display fixed in or deployable to a side-by-side arrangement with the first display and wherein the moveable display comprises a third display fixed in or deployable to an overlapping arrangement with respect to the first and/or second displays in the side-by-side arrangement, and further comprising:
displaying the composite image of the single scene across the first, second and third displays, wherein the portion of the single scene displayed on the third display corresponds to the relative position of the third display with respect to the first and second displays.

15. A handheld electronic device, comprising:
a housing including a fixed display on a surface thereof;
a moveable display on the surface of the housing and configured slide along the surface to variably overlap portions of the fixed display;
a position sensor adjacent the surface of the housing and configured to generate a signal indicating a relative position of the moveable display with respect to the fixed display; and
a display controller configured to determine the relative position of the moveable display with respect to the fixed display in response to the signal generated by the position sensor and selectively manipulate an image displayed on the moveable display and/or the fixed display according to the relative position of the moveable display to the fixed display.

16. The device of claim 15, wherein the display controller is configured to detect movement of the moveable display in a direction along the surface of the housing responsive to the signal from the position sensor and scroll an image displayed on the fixed display in the direction responsive to detecting the movement of the moveable display in the direction.

17. The device of claim 15, wherein the display controller is configured to display information associated with a selected item on one of the fixed display and the moveable display responsive to receiving a signal indicating user selection of the item on the other of the fixed display and the moveable display.

18. The device of claim 15, wherein the display controller is configured to display a window including an image portion within a boundary thereof on one of the fixed display and the moveable display and display an enlarged view of the image portion within the boundary of the window on the other of the fixed display and the moveable display.

19. The device of claim 15, wherein the display controller is configured to display a composite image of a single scene across the fixed and moveable displays such that a portion of the single scene is displayed on the moveable display and is varied according to the relative position of the moveable display with respect to the fixed display, and wherein the display controller is further configured to magnify and/or highlight points on at least part of the portion of the single scene displayed on the moveable display.

20. The device of claim 15, wherein the display controller is configured to detect movement of the moveable display in a direction along the surface of the housing responsive to the signal from the position sensor and modify a device setting and/or initiate a device function responsive to detecting the movement of the moveable display.
